(19) United States
(12) Patent Application Publication
(10) Pub. No.: US 2004/0012135 A1
(43) Pub. Date: Jan. 22, 2004

(54) Spring and a dispenser comprising same

(76) Inventors: Aline Abergel, Boulogne Billancourt (FR); Firmin Garcia, Evreux (FR)

Correspondence Address: SUGHRUE MION, PLLC, 2100 PENNSYLVANIA AVENUE, N.W., WASHINGTON, DC, 20037, US

(21) Appl. No.: 10/362,559

(22) PCT Filed: Aug. 23, 2001
(86) PCT No.: PCT/FR01/02659

(30) Foreign Application Priority Data
Aug. 25, 2000 (FR) 00/11007

(51) Int. Cl. F16F 1/06

(52) U.S. Cl. 267/166

(57) ABSTRACT

A spring (4) made up of two leaves (41, 42) interconnected via a bend (40) so that, at rest, the leaves form an acute angle, said leaves being elastically deformable relative to each other by pivoting about the bend, said spring being characterized in that it is further provided with energy accumulation means (43, 44) imparting to the spring initial resistance-to-deformation having a resistance threshold that must be overcome in order to continue suddenly to move the two leaves towards each other.

The present invention relates to a spring and to a dispenser device using such a spring as a return spring serving to return the dispenser to a rest position. However, the spring is not limited merely to being implemented in such a dispenser. It may also be used in any other system requiring resilient return means.

Numerous types of spring already exist, the most commonly used being the conventional spiral spring that is cylindrical or more rarely conical. When such a spiral spring is to be mounted in automated manner into a particular device or system, it is necessary to position the spring angularly and to take hold of it using a suitable machine such as a robot. This is because a spiral spring is very difficult to stand upright because of its cylindrical and elongate configuration. It cannot thus be fed directly into a device at a suitable place from loose storage.

The present invention seeks to define another type of spring that is advantageously easier to position angularly in that the spring comes almost automatically into a position in which it can perform its spring function.

The following springs are also known and are described in Documents U.S. Pat. No. 2,432,288 and U.S. Pat. No. 4,932,508.

In Document U.S. Pat. No. 2,432,288, the spring is made up of two leaves curved back on each other, the end of one leaf coming into contact with the other leaf. By pressing on that spring in order to bring the leaves towards each other, the force required to deform the spring merely increases. While the leaves are being brought towards each other, the tab that forms the free end of the leaf in contact with the other leaf is subjected to continuous and continuously increasing deformation.

Document U.S. Pat. No. 4,932,508 describes an overrunning roller clutch with a leaf spring implemented in a zigzag configuration. Each leaf of the spring is provided with a window from which a curved tab is cut out that can come into contact with the other leaf when the spring is compressed. In that example too, the force required to compress the spring merely increases as the as the curved tabs deform.

Therefore, with that type of spring, there is no guarantee that the spring is completely compressed or loaded, because the required compression force increases. It is possible that the compression force might not be sufficient, so that the spring is compressed only in part. In the field of fluid dispensers using return springs, this is particularly detrimental because the metered quantities or “doses” of fluid dispensed are not accurate and constant.

An object of the present invention is to remedy this problem by defining a spring that is guaranteed to be compressed to its maximum extent.

To this end, the present invention provides a spring made up of two leaves interconnected via a bend so that, at rest, the leaves form an acute angle, said leaves being elastically deformable relative to each other by pivoting about the bend, said spring being characterized in that it is further provided with energy accumulation means imparting to the spring initial resistance-to-deformation having a resistance threshold that must be overcome in order to continue suddenly to move the two leaves towards each other.

The energy accumulated is potential energy so that the spring is initially subjected to precompression. It is only by overcoming this initial resistance that the spring can be actuated suddenly. This guarantees that it is compressed to the maximum extent.

Advantageously, the energy accumulation means are provided between the two leaves.

In a practical embodiment, the energy accumulation means comprise a tab that is integral with a leaf and that extends via its free end towards the other leaf. Advantageously, the tab is inclined substantially towards the bend, the other leaf defining an abutment surface that is substantially perpendicular to the tab, against which surface the free end of the tab is urged while the two leaves are being brought towards each other, thereby generating initial resistance to deformation that must be overcome in order to continue to bring the leaves towards each other, the free end of the tab then being released suddenly from the abutment surface so as to extend towards the bend. Preferably, the abutment surface is formed by a bulge on the other leaf. A spring provided with such energy accumulation means may also be made from a cut-out and folded metal blade or from molded plastic.

According to another advantageous characteristic, the leaves are substantially identical, advantageously straight, and substantially plane. In addition, the width of each of the leaves is greater than half its length. As a result, the spring is positioned almost automatically on one of the two leaves so that it can perform its spring function by pressing on the other leaf which is not standing on the bearing surface. Advantageously, the bend extends over the entire width of each of the leaves.

The spring thus has a configuration that is particularly simple since it is shaped like a somewhat open hairpin, and can be manufactured easily from a cut-out and folded metal blade or else from molded plastic.

The invention also provides a fluid dispenser comprising:

a reservoir containing said fluid and provided with at least one actuating wall which is pressed in order to reduce the volume of the reservoir; and

a dispensing orifice via which the fluid is dispensed;

said fluid dispenser being characterized in that the reservoir contains a spring as defined above.

Advantageously, a removable closure element closes off the dispensing orifice, thereby isolating the reservoir from the outside, the spring being stressed so as to occupy a minimum volume so long as the closure element closes off the dispensing orifice. Thus, the spring relaxes in order to increase the volume of the reservoir as soon as the closure element is removed, by means of air entering the reservoir through the dispensing orifice.

The use of such a spring is particularly advantageous in such a fluid dispenser because it is necessary merely to deposit the spring in the reservoir while the dispenser is being manufactured, without having to given any concern to its angular positioning, because the spring comes into position automatically on one of the two leaves. Thus, a prior operation in which the spring is angularly positioned and held is omitted. In addition, such a spring is less expensive to manufacture.

Furthermore, the energy accumulation means make it possible to generate precompression guaranteeing that the dose of fluid is dispensed in full.

The invention is described more fully below with reference to the accompanying drawings which, by way of non-limiting example, give an embodiment of the spring of the invention, and an implementation in a particular fluid dispenser.

In the figures:

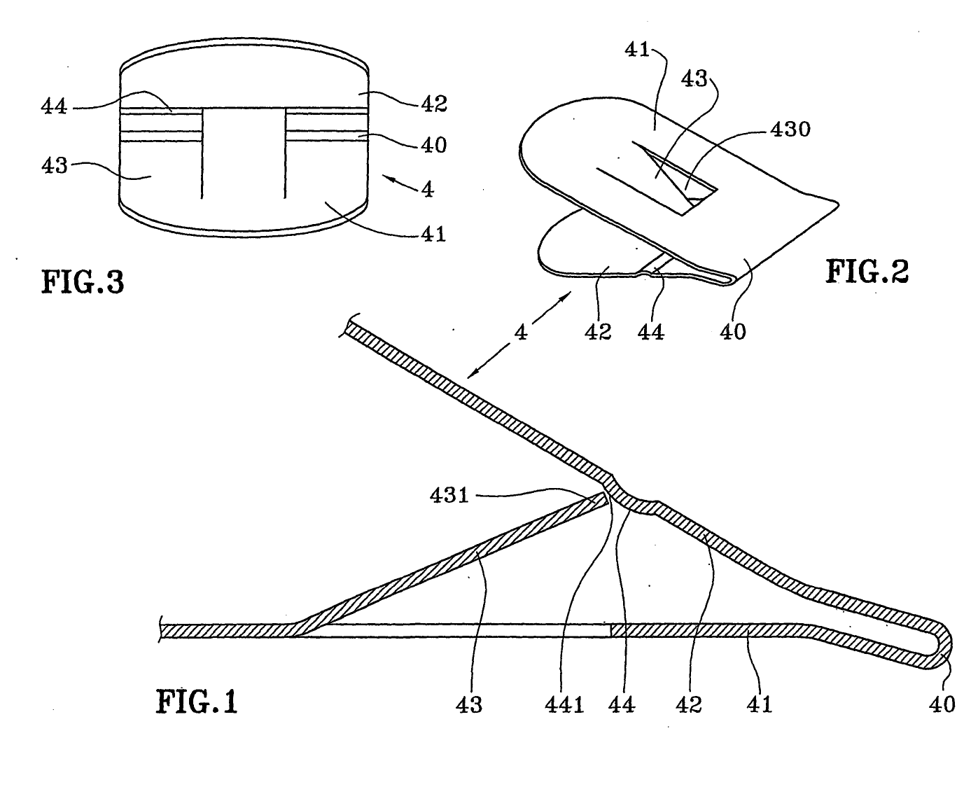

FIG. 1 is a vertical section view through a spring of the invention;

FIG. 2 is a perspective view of the spring of FIG. 1;

FIG. 3 is an end view looking into the spring of FIGS. 1 and 2;

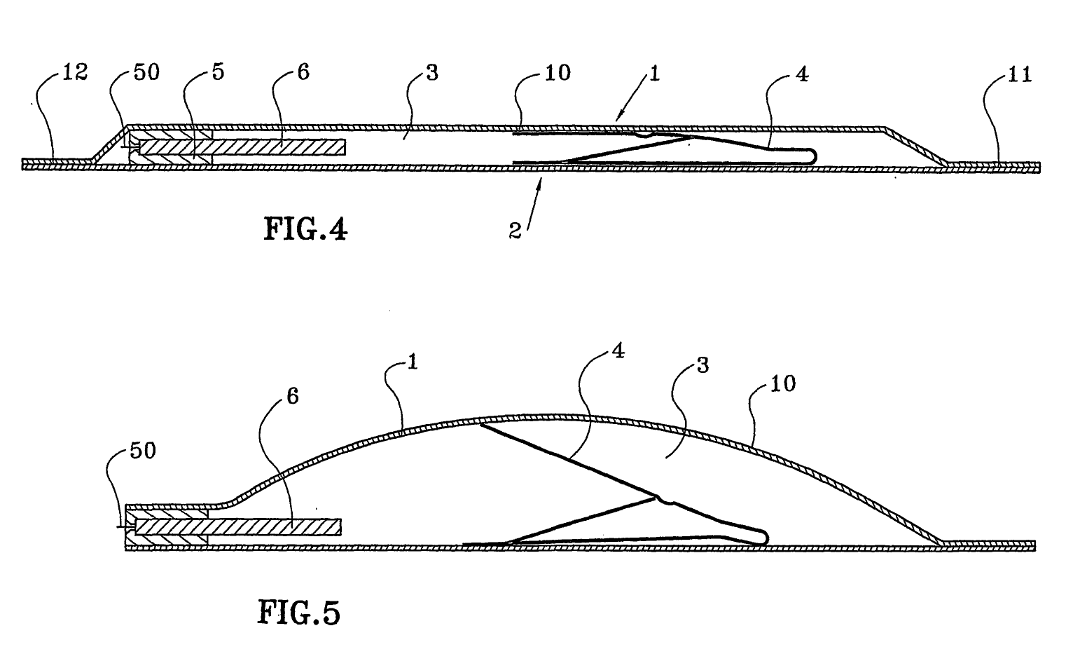

FIG. 4 is a vertical section view through a fluid dispenser using a spring of FIGS. 1 to 3, said dispenser being in the non-used state; and

FIG. 5 is a section view of the dispenser of FIG. 4, as ready to be used.

The spring shown in the figures and used to illustrate the present invention is in the general shape of an open hairpin. The spring is given overall numerical reference 4 and it is made up of two leaves 41 and 42 interconnected at one end via a bend 40. The two leaves 41 and 42 extend at an acute angle relative to each other, e.g. at an angle lying in the range 20° to 60°. It is easy to understand that such a hairpin-shaped clip is easy to deform elastically by moving its leaves towards each other, by means of a deforming/pivoting movement about the bend 40. By choosing a suitable material such as metal or plastic, having good shape memory, the two leaves return resiliently to their original position as soon as the pressing force ceases to be exerted on its leaves. This is a particularly simple embodiment for such a spring.

Preferably, the leaves of the spring are relatively wide compared with their length: the width of the leaves may, for example, be greater than one half of the length of the leaves. In addition, the two leaves are advantageously substantially straight and plane, so that they offer large and particularly stable bearing surfaces. Preferably, both leaves are substantially identical so that it makes no difference whatsoever which leaf the spring stands on. With such a configuration, the spring comes into position automatically on one of the two leaves. It is almost impossible for the spring to be positioned on the edges of the leaves: this is made even more improbable since the free ends of the leaves are rounded.

In an advantageous feature of the invention, the spring includes energy accumulation means or precompression means enabling the spring to offer initial resistance to deformation that must be overcome in order to continue to bring the two leaves together. In practice, the energy accumulation means are in the form of a hard point opposing squeezing that the finger encounters when one of the two leaves is pressed. To make it possible to bring the leaves towards each other, it is necessary to overcome the hard point or point of resistance, thereby accumulating potential energy. The potential energy is then released suddenly as soon as the pressing force exceeds a certain resistance-to-deformation threshold which is determined by the energy accumulation means. Once the threshold is exceeded, the two leaves are then brought towards each other suddenly until they come into contact with each other.

In a practical embodiment, the energy accumulation means are situated between the two leaves 41 and 42, and are in the form of a tab 43 which co-operates with an abutment surface 441. More precisely, the tab 3 is connected via one of its ends to one of the leaves 41, and it extends in inclined manner towards the bend 40. The tab 43 is angularly positioned such that its free end 431 faces towards an abutment surface 441 advantageously formed by a bulge 44 formed on the other leaf 42. The tab 43 is advantageously formed directly by the leaf 41 in which a U-shaped cut is made to cut out a tongue which is then folded towards the inside of the spring to form the tab 43. As a result, the leaf 41 is formed with a window 430 within which the tab 43 can lie when it is urged resiliently into it. Thus, the tab 43 does not generate any extra thickness.

In addition, the bulge 44 on the leaf 42 is formed such that the abutment surface 441 is situated in alignment with the tab 43 immediately after its free end 431. In the embodiment shown in FIG. 1, the free end 431 of the tab 43 does not come into contact with the abutment surface 441 in the rest position. However, the free end 431 may also come into contact with the abutment surface 441 in the rest position without modifying the principle of the spring. It can easily be understood from FIG. 1 that bringing the two leaves 41 and 42 towards each other results in bringing the free end 431 of the tab 43 into contact with the abutment surface 441 of the leaf 42. It can also be observed that the abutment surface 441 extends substantially perpendicularly to the tab 43 so that the free end 431 of the tab 43 does not directly tend to slide on said abutment surface 441. Thus, in a first stage, while the leaf 42 is being brought towards the leaf 41, the free end 431 remains in abutment on the surface 441, thereby generating a hard point corresponding to the above-mentioned resistance to deformation. By increasing the pressing force on the leaf 42, said leaf then tends to deform at its point of contact with the tab 43, thereby causing the free end 431 to slide on the abutment surface 441. When the resistance threshold is reached, the free end 431 then slides suddenly over the bulge 44 and the leaf 42 can then fold down rapidly onto the leaf 41. In the final deformation position, the leaf 42 is substantially parallel to the leaf 41, and the tab 42 then lies within the window 430 with its free end 431 situated beyond the bulge 44 going towards the bend 40 The resistance-to-deformation threshold is, in particular, determined by the inclination of the tab 43 relative to the leaf 41 and to the leaf 42, and by the angle of incidence of the abutment surface 441 relative to the direction in which the tab 43 extends. It is possible to vary these two parameters to obtain a spring with an initial resistance-to-deformation threshold of different value.

Such a spring may, for example, be made from a cutout and folded metal blade. It is also possible to make the spring of a molded plastics material.

A preferred use of a spring as described above is in a fluid dispenser as shown in FIGS. 4 and 5.

In this non-limiting embodiment, the dispenser may be made up of two sheets of flexible laminated film 1 and 2 which are sealed together around their peripheries 11, 12 so as to define between them a volume that corresponds substantially to the volume of a fluid reservoir 3. An insert 5 may also be disposed between the two sheets 1 and 2: the insert 5 defines a dispensing orifice 50 and a recess in which a porous fiber 6 may be received so as to extend inside the reservoir 3. The fiber 6 serves to become impregnated with fluid contained inside the reservoir 3. Once the fiber is soaked with fluid, it is necessary merely to cause a stream of air to flow through the fiber, thereby generating two-phase dispensing at the dispensing orifice 50 of the insert 5. In front of the dispensing orifice 50, the two sealed-together sheets 1 and 2 define a tear-off or fold-back tongue 12 which closes off the dispensing orifice 50 so as to isolate the reservoir 3 from the outside.

In the invention, the reservoir 3 contains a spring 4 which is disposed between the two sheets 1 and 2. As can be seen in FIG. 2, the spring 4 acts at least on one wall 1 of the dispenser, which may be the actuating wall, so as to increase the internal volume of the reservoir 3. According to a particularly advantageous characteristic, the spring 4 is stressed into its fully compressed state so long as the closure element 12 closes off the dispensing orifice 50 and thus isolates the reservoir 3 from the outside. In other words, the reservoir 3 is sealed off on being manufactured, with the spring stressed into its maximum compressed state, so that the reservoir is then at its minimum volume. In this state, as shown in FIG. 1, the reservoir 1 contains almost nothing but fluid, and no gas or hardly any gas. Since the reservoir 3 is fully isolated from the outside by the closure element 12, the spring 4 cannot relax inside the reservoir 3 because of the atmospheric pressure that is exerted on the walls 1 and 2 of the reservoir. The dispenser can then be stored before use in this state, and it has a particularly small thickness which is defined substantially by the thickness of the spring 4 in its fully compressed state added to the cumulative thickness of the two sheets of film 1 and 2. The spring 4 then defines a minimum volume in which the fluid is stored substantially without being subjected to any pressure. Thus, there is no risk of leakage due to the reservoir 3 being crushed. Such a dispenser may, for example, be inserted into a magazine because it is particularly flat and particularly pressure resistant.

As soon as the closure element 12 is removed, air can penetrate into the reservoir 3 via the dispensing orifice 50 so that the spring 4 can relax inside the reservoir, thereby increasing its internal volume. The reservoir 3 is then filled with the fluid and with gas (air, in general). To dispense the fluid as a spray, it is necessary merely to act on the wall 1, e.g. with the thumb, against the action of the spring 4 so as to deliver air through the fiber 6 soaked with fluid. By passing through the soaked fiber 6 the air generates a two-phase spray at the dispensing orifice 50. As soon as the actuating wall 1 ceases to be pressed, it returns to its shape shown in FIG. 5 because of the resilient action of the spring 4.

The spring 4 acts as a spacer in the storage state (FIG. 4) by determining the minimum volume for the reservoir 3, it acts as a primer when the closure element 12 is torn off by increasing the volume of the reservoir 3, and it acts as a return spring when the dispenser is actuated by pressing on the actuating wall 1.

The use of a spring as defined above with reference to FIGS. 1 to 3 is particularly advantageous in this type of dispenser because it can be disposed in the reservoir while the dispenser is being manufactured, without any special angular positioning be necessary, since the spring is automatically positioned on one of its two leaves. In addition, it is extremely flat in the fully compressed state, which makes it possible to obtain dispensers that are particularly flat, which is advantageous for the above-mentioned reasons. In addition, the use of such a spring equipped with energy accumulation means makes it possible to obtain a precompression dispenser. The actuating wall 10 cannot be pushed in gradually or linearly because of the presence of said spring. It is necessary to apply a force on the actuating wall 10 that is high enough to overcome the resistance-to-deformation threshold of the spring. As soon as the pressure exceeds said resistance threshold, the actuating wall 10 is pushed in suddenly and the mixture of fluid and of gas inside the reservoir 3 is put under pressure suddenly, which causes it to be delivered very rapidly through the fiber 6 and through the dispensing orifice 50. Two-phase spraying of good quality is thus guaranteed. This does not apply with a conventional coil or spiral spring which does not have a resistance-to-deformation threshold.

By means of this special spring which integrates an energy accumulation function, it is possible to obtain a precompression dispenser from mere fluid packaging that does not have shape memory.

1/ A spring (4) made up of two leaves (41, 42) interconnected via a bend (40) so that, at rest, the leaves form an acute angle, said leaves being elastically deformable relative to each other by pivoting about the bend, said spring being characterized in that it is further provided with energy accumulation means (43, 44) imparting to the spring initial resistance-to-deformation having a resistance threshold that must be overcome in order to continue suddenly to move the two leaves towards each other.

2/ A spring according to claim 1, in which the energy accumulation means are provided between the two leaves.

3/ A spring according to claim 1 or claim 2, in which the energy accumulation means comprise a tab (43) that is integral with a leaf (41) and that extends via its free end (431) towards the other leaf (42).

4/ A spring according to claim 3, in which the tab (43) is inclined substantially towards the bend (40), the other leaf (42) defining an abutment surface (441) that is substantially perpendicular to the tab (43), against which surface (441) the free end (431) of the tab (43) is urged while the two leaves are being brought towards each other, thereby generating initial resistance to deformation that must be overcome in order to continue to bring the leaves towards each other, the free end (431) of the tab then being released suddenly from the abutment surface (441) so as to extend towards the bend (40).

5/ A spring according to claim 4, in which the abutment surface (441) is formed by a bulge (44) on the other leaf (42):

6/ A spring according to any preceding claim, in which the leaves (41 & 43) are substantially straight, plane, and identical.

7/ A spring according to any preceding claim, in which each of the leaves (41, 42) is of width that is greater than half its length.

8/ A spring according to any preceding claim, made integrally from a cut-out and folded metal blade.

9/ A fluid dispenser comprising:
a reservoir (3) containing said fluid and provided with at least one actuating wall (10) which is pressed in order to reduce the volume of the reservoir; and
a dispensing orifice (50) via which the fluid is dispensed;
said fluid dispenser being characterized in that the reservoir (3) contains a spring (4) according to any preceding claim.

10/ A dispenser according to claim 9, in which a removable closure element (12) closes off the dispensing orifice (50), thereby isolating the reservoir (3) from the outside, the spring (4) being stressed so as to occupy a minimum volume so long as the closure element closes off the dispensing orifice.

11/ A dispenser according to claim 10, in which the spring (4) relaxes in order to increase the volume of the reservoir as soon as the closure element is removed, by means of air entering the reservoir through the dispensing orifice.
